(19) United States
(12) Patent Application Publication
(10) Pub. No.: US 2008/0176701 A1
(43) Pub. Date: Jul. 24, 2008

(54) Geared motor reducer and geared motor

(75) Inventors: Akira Yamamoto, Obu-shi (JP); Mitsuhiro Tamura, Obu-shi (JP)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Sumitomo Heavy Industries, Ltd.

(21) Appl. No.: 12/010,176

(22) Filed: Jan. 22, 2008

(30) Foreign Application Priority Data
Jan. 22, 2007 (JP) 2007-11530

(51) Int. Cl. F16H 1/32

(52) U.S. Cl. 475/178

(57) ABSTRACT

An inner pin plate having an inner pin integrally formed thereon is arranged on an axial motor side of an external gear, the inner pin being capable of restraining rotation of the external gear on its axis. An inner pin plate functions as a part of a casing body of the reducer. An output flange of the reducer, integrally formed on the internal gear, is arranged on an axial counter-motor side of the external gear. On the axial counter-motor side of the external gear, an eccentric body shaft is supported by a casing body, through a first bearing, the output flange, the internal gear, and a cross roller bearing arranged between the internal gear and a casing body.

### BACKGROUND OF THE INVENTION

1. Field of the Invention

The present invention relates to a geared motor reducer and a geared motor.

2. Description of the Related Art

Japanese Patent Application Laid-Open No. 2003-21198 discloses a reducer such as shown in FIG. 4.

This reducer 10 has a planetary gear mechanism 17 for making an external gear 15 rotate eccentrically inside an internal gear 13 so that the two gears 13 and 15 are in mesh with each other, thereby extracting a rotational component of the internal gear 13 occurring about its axis.

Geared motors having this type of reducer 10 and a not-shown motor integrally coupled to each other are also widely known. Geared motors can be used in various aspects, whereas a shortening of an axial dimension is highly demanded of in some cases depending on the applications or constraints of the installation space.

To suppress an increase in the axial dimension, the reducer 10 disclosed in the foregoing Japanese Patent Application Laid-Open No. 2003-21198 is configured to include a first carrier member 18 which has a bearing mounting portion 16 (16A, 16B) radially protruding on the outer side of the internal gear 13. A speed change mechanism region 14 is located between a pair of planes 12A and 12B, the planes 12A and 12B passing both axial ends of the internal gear 13 in mesh with the external gear 15 and are perpendicular to the axial direction. A cross roller bearing 21 which are laid between the bearing mounting portion 16 and an internal support member 20 so as to allow relative rotation between the first carrier member 18 and the internal support member 20 within the speed change mechanism region 14.

Note that the reference numeral 24 represents an oil seal, and 25 represents a second carrier member.

According to the foregoing configuration, the first carrier member 18 out of the two carrier members 18 and 25 constitutes rigid bodies that extend from the radial center area to the peripheral area of the reducer 10. Nevertheless, the presence of the oil seal 24 around the second carrier member 25 makes the second carrier member 25 supported with carrier bolts 27 alone in a so-called cantilevered state, which has produced the problem that it is difficult to increase the rigidity of the entire reducer. For increased rigidity, each individual member must therefore be increased in axial dimension (member thickness), which has resulted in greater weight and higher cost.

### SUMMARY OF THE INVENTION

In view of the foregoing problems, various exemplary embodiments of this invention provide a geared motor reducer and a geared motor using this reducer which are capable of reducing (shortening) the axial dimension of the reducer and further increasing the rigidity of the entire reducer as well, so that smoother rotations can be maintained over a long period of time.

The present invention solves the foregoing problems by the provision of a geared motor reducer to be coupled with a motor, the reducer comprising: a planetary gear mechanism having an external gear, an internal gear meshing with the external gear, an eccentric body shaft for making the external gear rotate eccentrically, and an inner pin capable of restraining rotation of the external gear on its axis; an inner pin plate having the inner pin integrally formed thereon, the inner pin plate being arranged on an axial motor side of the external gear and functioning as a part of a casing body of the geared motor reducer, the reducer and the motor being capable of connecting through the inner pin plate; a first bearing which supports the eccentric body shaft on an axial counter-motor side of the external gear; an output flange which is integrated with the internal gear on the axial counter-motor side of the external gear, the output flange being arranged on an outer periphery of the first bearing; and a cross roller arranged between an outer periphery of the internal gear and the casing body.

According to the present invention, high rigidity is ensured on the axial motor side of the external gear by means of the inner pin plate which functions as a part of a casing body of the reducer. The reducer and the motor are capable of connecting through the inner pin plate. The inner pin is integrally formed on this rigidity-ensured inner pin plate. This makes it possible to reduce the axial length (as much as due to the cantilevering) and maintain high rigidity (despite the cantilevering). Meanwhile, on the axial counter-motor side of the external gear, a connection from the eccentric body shaft to the outermost casing body of the reducer is established through the first bearing, the output flange, the internal gear, and a cross roller bearing, which are all “rigid bodies.” With this synergistic configuration, the planetary gear mechanism eventually comes to have high-rigidity members arranged on both axial sides, and can thus maintain the entire reducer at extremely high rigidity.

Meanwhile, the geared motor reducer according to the present invention is coupled with a motor through the foregoing rigidity-ensured inner pin plate, and thus has high “coupling rigidity” with the motor. This inner pin plate also provides the function of a so-called reducer cover or motor cover, which can thus be omitted to reduce the axial length accordingly further when manufacturing a geared motor product.

According to the present invention, it is possible to reduce the axial dimension of the reducer and further increase the rigidity of the entire reducer as well. In consequence, it is possible to reduce the axial length and maintain even smoother rotations over a long period of time.

### BRIEF DESCRIPTION OF THE DRAWINGS

FIG. 1 is a longitudinal sectional view of a geared motor which is an exemplary embodiment of the present invention;

FIG. 2 is a cross-sectional view taken along the line II-II of FIG. 1;

FIG. 3 is a longitudinal sectional view of a geared motor which is another exemplary embodiment of the present invention; and

FIG. 4 is a longitudinal sectional view showing an example of a conventional reducer.

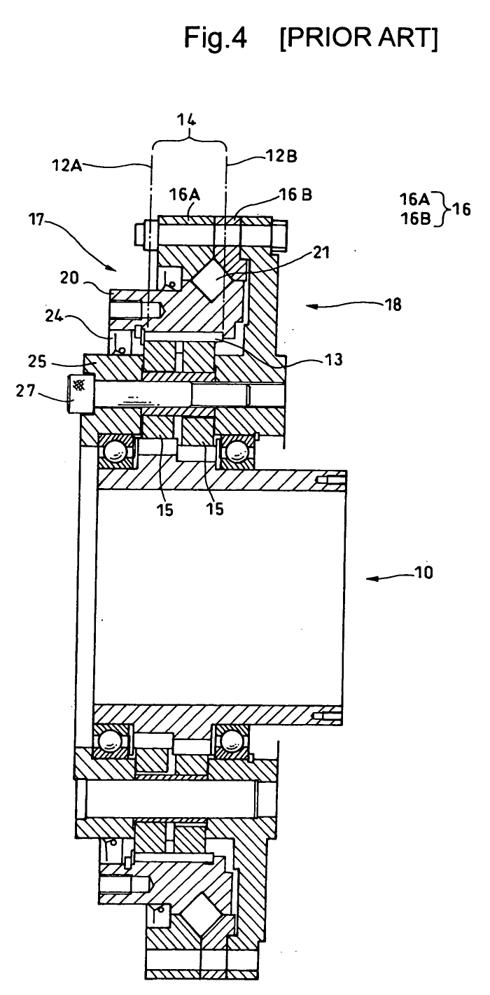

### DETAILED DESCRIPTION OF THE PREFERRED EMBODIMENTS

Hereinafter, an exemplary embodiment of the present invention will be described in detail with reference to the drawings.

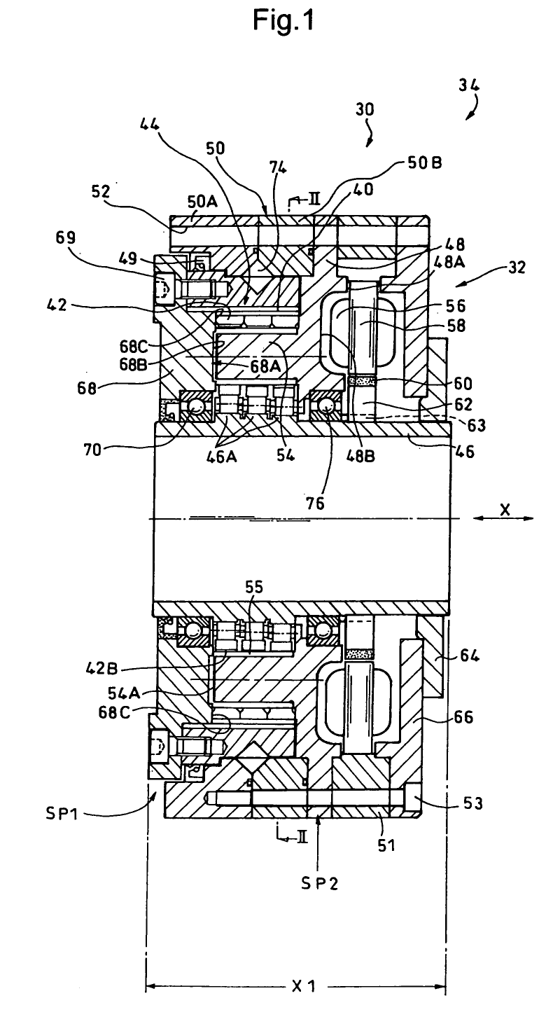

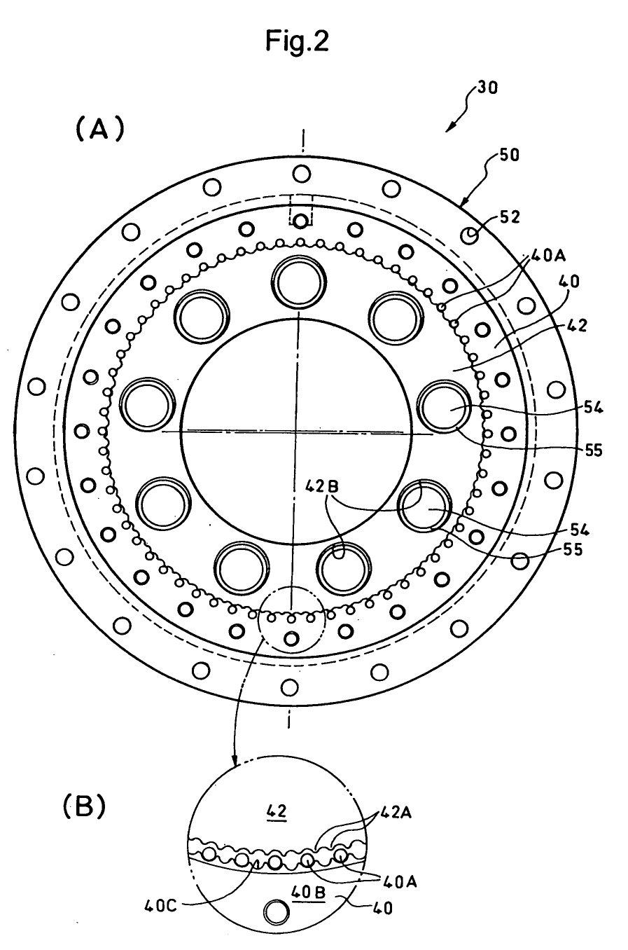

FIG. 1 shows a flat geared motor 34 which is formed by coupling a geared motor reducer 30 to a flat motor 32. FIG. 2 is a cross-sectional view taken along the line II-II of FIG. 1.

The reducer 30 includes a planetary gear mechanism 44 for making external gears 42 rotate eccentrically inside an internal gear 40 so that the gears 40 and 42 are in mesh with each other, thereby extracting a rotational component of the internal gear 40 occurring about its axis. The internal teeth of the internal gear 40 are composed of outer pins 40A. As schematically shown in FIG. 2(A) and partially enlarged in FIG. 2(B), outer pin grooves 40C are formed in a body 40B of the internal gear 40. The outer pins 40A are loaded into every other groove 40C each. The numbers of external teeth 42A of the external gears 42 are slightly (one, in the shown case) smaller than the number of outer pin grooves 40C (substantially equivalent to the number of internal teeth). While all the outer pin grooves 40C are preferably loaded with the outer pins 40A, only a half are loaded in this example in view of reduced cost and assembly man-hours.

In order to ensure high transmission capacity, there are provided three external gears 42. The external gears 42 are laid across respective eccentric bodies 46A which are integrally formed on an eccentric body shaft 46. The eccentric bodies 46A are decentered into respective directions that are shifted by 120° circumferentially from each other.

Consequently, the external gears 42 maintain phase differences of 120° from each other while rotating with the rotation of the eccentric body shaft 46. This can realize the eccentric rotation of the external gears 42.

In this reducer 30, an inner pin plate 48 is fixed to a center case 50B, which is a part of a casing body 50 of the reducer 30 on one side of the external gears 42 in the axial direction X (on the side of the flat motor 32) with bolts 53. Thus the inner pin plate 48 functions as a part of the casing body 50. The casing body is composed of: an outer case 50A where an oil seal 49 and a cross roller bearing 74 are arranged between the outer case 50A and the internal gear 40; and the center case 50B which is provided with the cross roller bearing 74 alone. Inner pins 54 are integrally formed on the inner pin plate 48. The inner pins 54 pass through inner pin holes 42B of the external gears 42 in the axial direction X, and can restrain the rotation of the external gears 42 on their axes. Inner rollers 55 are attached to the peripheries of the inner pins 54 in order to reduce sliding resistances between the inner pins 54 and the inner pin holes 42B of the external gears 42.

An output flange 68, which is integrated with the internal gear 40, is arranged on the axial counter-motor side of the external gears 42. A side 68A of the output flange 68 is opposed to extremities 54A of the inner pins 54, and recesses 68B are formed in the areas opposed to these inner pins 54. This side 68A is also machined into a machined portion 68C at areas other than the recesses 68B, and the external gears 42 are axially positioned thereto.

The reducer 30 and the flat motor 32 can be coupled to each other via this inner pin plate 48 by using bolts which are inserted through bolt holes 52. The flat motor 32 has coil ends 56, a stator 58, magnets 60, and a rotor 62. The outer periphery of the stator 58 makes a motor casing 51 which is in contact with the inner pin plate 48, and is fixed with the casing body 50 of the reducer 30 by the bolts 58. The reference numeral 52 represents a through hole for a bolt (not shown) for fixing the flat geared motor 34 to be inserted through.

The coil ends 56 tend to occupy space in the axial direction. Recesses 48B capable of accommodating the coil ends 56, when connected with the flat motor 32, are thus formed in a side 48A of the inner pin plate 48 where the flat motor 32 is connected. For the purpose of reducing the axial dimension, these recesses 48B may sometimes be a simple step depending on the shape of the coil ends 56 (for example, see a step 48D of an inner pin plate 48a to be described later).

The eccentric body shaft 46 of the reducer 30 is axially extended to the flat-motor side beyond the inner pin plate 48, and is directly coupled to the rotor 62 of the flat motor 32 via a spline 63. That is, the eccentric body shaft 46 also functions as the motor shaft of the flat motor 32. This eccentric body shaft 46 is also supported by the casing body 50 of the reducer 30, with a first support system SP1 which is composed of: a first bearing 70 arranged on the outer periphery of the eccentric body shaft 46; the output flange 68 arranged on the outer periphery of the first bearing 70; the internal gear 40 integrated with the output flange 68 using the bolts 69; and the cross roller bearing 74 arranged on the outer periphery of the internal gear 40.

In addition to the support of the first support system SP1, this eccentric body shaft 46 is also supported by the casing body 50 of the reducer 30, with a second support system SP2 which is composed of: a second bearing 76 arranged on the outer periphery of the eccentric body shaft 46; and the inner pin plate 48 arranged on the outer periphery of the second bearing 76. As a result, high-rigidity members are arranged in succession from the radial center to the outermost casing body 50 of the reducer 30 on both sides of the external gears 42 in the axial direction X.

Note that the reference numeral 64 in the drawings represents a resolver (or encoder) for controlling the rotation of the flat motor 32, and 66 represents an end cover (counter-reducer side cover).

A description will now be given of the operation of this reducer 30 and the flat geared motor 34 having the reducer 30.

When the flat motor 32 is energized to rotate the rotor 62, the eccentric body shaft 46 (also serving as a motor shaft) is rotated via the spline 63. The eccentric body shaft 46 rotates the three eccentric bodies 46A which are integrally formed on the eccentric body shaft 46. Due to the rotation of these eccentric bodies 46A, the three external gears 42 make eccentric rotation while maintaining the circumferential phase differences of 120°. In this instance, the inner pins 54 pass through the inner pin holes 42B of the external gears 42, and these inner pins 54 are integral with the inner pin plate 48. The inner pin plate 48 is fixed to the casing body 50 so as to function as a part of the casing body 50.

Since their rotations on their axes are restricted by the inner pins 54, the external gears 42 make a swing alone (without rotation). This swing causes the phenomenon that the meshing points between the internal gear 40 and the external gears 42 shift in succession. The number of teeth of the internal gear 40 (equivalent to the number of outer pin grooves 40C) is different from the numbers of teeth of the external gears 42 by “1,” and the internal gear 40 therefore rotates on its axis as much as an angle corresponding to the difference in the number of teeth from the external gears 42 each time the meshing points between the internal gear 40 and the external gears 42 shift through a single round (each time the eccentric body shaft 46 makes a single rotation). This consequently produces the operation of significant speed reduction that the internal gear 40 rotates as much as an angle of 360°/(the number of teeth of the internal gear 40) for a single rotation of the eccentric body shaft 46.

In this instance, the rotation of the internal gear 40 is supported by the casing body 50 via the cross roller bearing 74. The rotation of the internal gear 40 is transmitted to the output flange 68 which is integrated with this internal gear 40 using the bolts 69. Thus, the rotation of the internal gear 40 is output as the rotation of the output flange 68.

Attention will now be given to the support systems of the individual members. In the present exemplary embodiment, the coupling on the axial counter-flat-motor side of the external gears 42 is established from the eccentric body shaft 46 to the outermost casing body 50 of the reducer 30 through the first bearing 70, the output flange 68, the internal gear 40, and the cross roller bearing 74, which are all “rigid bodies,” thereby forming the first support system.

Moreover, in the present exemplary embodiment, the coupling on the axial flat-motor side of the external gears 42 from the eccentric body shaft 46 to the outermost periphery is established by rigid members or the second support system SP2 including the second bearing 76 and the inner pin plate 48. Since the inner pin plate 48 is sandwiched between the casing body 50 of the reducer 30 and the motor casing 51 and is firmly fixed by the bolts 53, high rigidity is also ensured even on the axial motor side of the external gears 42. In addition, the inner pins 54 for restraining the rotation of the external gears 42 on their axes are integrally formed on the inner pin plate 48 of this rigidity-ensured second support system SP2. Consequently, the inner pins 54 can maintain high rigidity even if they are “cantilevered” for reduced axial length.

As a result, the planetary gear mechanism 44 can eventually maintain the entire reducer 30 at extremely high rigidity due to the formation of the first and second support systems SP1 and SP2 having high rigidity on both axial sides of the external gears 42.

Besides, the geared motor reducer 30 according to the present exemplary embodiment is coupled with the flat motor 32 through the foregoing rigidity-ensured inner pin plate 48, and thus has high coupling rigidity. This inner pin plate 48 also provides the function of a so-called reducer cover or motor cover, which is omitted to reduce the axial length accordingly.

Moreover, this geared motor 34 uses the flat motor 32, and is thus configured to be capable of reducing the axial length in the first place. In addition, the side 48A of the inner pin plate 48 for the flat motor 32 to be connected to has the recesses 48B for accommodating the coil ends 56 of this flat motor 32. This avoids interference between the coil ends 56 and the inner pin plate 48 while achieving axial downsizing. Furthermore, this inner pin plate 48 is firmly held between the reducer casing 50 and the motor casing 51, and thus can maintain high rigidity even if the recesses 48B are formed.

The formation of the recesses 68B in the side 68A of the output flange 68 at areas opposed to the inner pins 54 also avoids axial interference between the inner pins 54 and the output flange 68. This side 68A is also machined at the portion 68C other than the recesses 68B, and this machined portion 68C provides the function of positioning the external gears 42 in the axial direction. This makes it possible to omit thrust washers and the like for both cost saving and axial reduction at the same time. When the recesses 68B are formed in the side 68A before machining, the area to be machined decreases as much as the areas of the recesses 68A. This provides the effect of saving the costs and reducing the machining time.

As a synergistic effect of these contrivances, the flat geared motor 34 according to the present exemplary embodiment can maintain high rigidity while supporting the eccentric body shaft 46, which also functions as a motor shaft, with the two first and second bearings 70 and 72 alone. This makes it possible to minimize the axial length X1 of the flat geared motor 34 when manufactured as a product and improve the rigidity of the entire reducer 30 as well, eventually allowing smooth rotations over a long period of time.

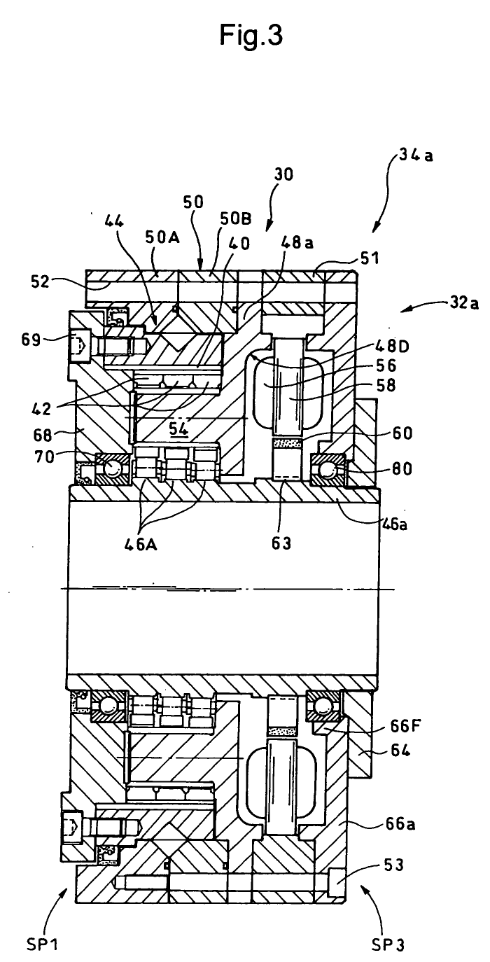

FIG. 3 shows another exemplary embodiment of the present invention. The foregoing exemplary embodiment has dealt with the configuration that the eccentric body shaft 46 (also functioning as a motor shaft) is supported with the first bearing 70 and the second bearing 76 arranged on respective sides of the external gears 42. In the present exemplary embodiment, the second bearing 76 is omitted, and an eccentric body shaft 46a is extended to an end cover (counter-reducer side cover) 66a of a flat motor 32a beyond an inner pin plate 48a so that it is supported with the first bearing 70 and a third bearing 80 which is arranged on the inner periphery of this end cover 66a. The end cover 66a has a leg portion 66F for the third bearing 80 to be built in.

In the present exemplary embodiment, the eccentric body shaft 46a, the third bearing 80, and the end cover 66a are coupled to the reducer casing 50 via the motor casing 51, thereby forming a third support system SP3. That is, as a result of combination with the foregoing first support system SP1, the highly-robust first and third support systems SP1 and SP3 are formed on respective axial sides of the flat geared motor 34a. Consequently, the eccentric body shaft 46a is supported with the first bearing 70 and the third bearing 80 at respective ends across a large span, which allows stable rotation support.

It should be appreciated that while the second bearing 76 of the foregoing exemplary embodiment is omitted in the present exemplary embodiment, the second bearing 76 may be left in place so as to ensure even higher rigidity.

In other respects, the configuration is common to that of the foregoing exemplary embodiment. The same or substantially the same parts are therefore designated by identical reference numerals, and a redundant description thereof will be omitted.

While in the foregoing exemplary embodiment the flat motor 34 has been used as a motor for the purpose of minimizing the axial length, the present invention is not limited to any particular type of motor. Any motor can be used to constitute a geared motor in which the motor and a reducer are combined with a minimum axial length.

The present invention is applicable to all sorts of industrial machines, distribution machines, and the like, and in particular, effectively applicable to applications where a reduction in the axial length is demanded.

The disclosure of Japanese Patent Application No. 2007-11530 filed Jan. 22, 2007 including specification, drawing and claim are incorporated herein by reference in its entirety.

1. A geared motor reducer to be coupled with a motor comprising:
a planetary gear mechanism having an external gear, an internal gear meshing with the external gear, an eccentric body shaft for making the external gear rotate eccentrically, and an inner pin capable of restraining rotation of the external gear on its axis;
an inner pin plate having the inner pin integrally formed thereon, the inner pin plate being arranged on an axial motor side of the external gear and functioning as a part of a casing body of the geared motor reducer, the reducer and the motor being capable of connecting through the inner pin plate;
a first bearing which supports the eccentric body shaft on an axial counter-motor side of the external gear;
an output flange which is integrated with the internal gear on the axial counter-motor side of the external gear, the output flange being arranged on an outer periphery of the first bearing; and
a cross roller arranged between an outer periphery of the internal gear and the casing body.

2. The geared motor reducer according to claim 1, wherein the eccentric body shaft is extended to the axial motor side beyond the inner pin plate to function as a motor shaft.

3. The geared motor reducer according to claim 1, further comprising a second bearing arranged on the axial motor side of the external gear, the second bearing being arranged between the outer periphery of the eccentric body shaft and the inner pin plate.

4. The geared motor reducer according to claim 1, wherein:
the inner pin axially pass through the external gear and an end plane of the inner pin is opposed to a side plane of the output flange; and
a recess is formed in the side plane of the output flange which faces to the end plane of the inner pin.

5. The geared motor reducer according to claim 4, wherein
the side plane of the output flange is machined at a portion other than the recess.

6. The geared motor reducer according to claim 5, wherein
the external gear is axially positioned by the machined portion.

7. A geared motor comprising a motor coupled to the geared motor reducer according to claim 1, wherein
the geared motor reducer and the motor are connected through the inner pin plate, and
the eccentric body shaft is extended to a counter-reducer side cover of the motor beyond the inner pin plate to function as a motor shaft.

8. A geared motor according to claims 7, wherein
the eccentric body shaft is supported with a third bearing arranged on an inner periphery of the counter-reducer side cover of the motor.
